(19) United States
(12) Patent Application Publication
(10) Pub. No.: US 2019/0305489 A1
(43) Pub. Date: Oct. 3, 2019

(54) Shielding metal plate

(71) Applicant: HARTING Electronics GmbH, Espelkamp (DE)

(72) Inventor: Dieter Lüttermann, Rahden (DE)

(73) Assignee: HARTING Electronics GmbH, Espelkamp (DE)

(21) Appl. No.: 16/316,418

(22) PCT Filed: Aug. 28, 2017
(86) PCT No.: PCT/DE2017/100721

§ 371 Date: Jan. 9, 2019

(30) Foreign Application Priority Data
Sep. 9, 2016 (DE) 10 2016 116 937.4

(51) Int. Cl. H01R 13/6593; H01R 13/58; H01R 13/6582

(52) U.S. Cl. CPC H01R 13/6593; H01R 13/6582; H01R 13/5837

(57) ABSTRACT

The invention relates to a shielding metal plate (3) suitable for connecting at least one shielded conductor. The shielding metal plate (3), which can be held in a housing of a plug connector, protects the held conductor from external, interfering influences. The shielding metal plate (3) can be variably adapted to different conductor cross-sections such that both thin and thick conductors can be connected.

### TECHNICAL FIELD

The disclosure relates to a shielding metal plate for use in an electrical connector.

### BACKGROUND

Shielding metal plates of such a type are inserted into plug connectors that are needed in order to transmit currents and/or signals. The currents and/or signals are transported to the plug connector by means of a conductor. Said conductor exhibits at least one core. In order that a trouble-free transmission can take place, the conductor is a shielded conductor. The shielding in this case serves for equalization of potential. For the effective removal of interference phenomena potentially arising on the cable shield, a contacting of the cable shield is necessary that is as frequent and/or extensive as possible.

U.S. Pat. No. 5,895,291 A presents a threaded cable gland for a plug connector with attached shield linkage. The shield linkage consists of two gutter-shaped elements. These elements are equipped with a detent option on the side facing toward the conductor. For the purpose of closing, the two halves are pressed together; consequently they close around the conductor in the form of a tube, and hook in a detent option.

An electromagnetic shielding for an electrical connector, as well as the associated electrical connector, is disclosed in DE 10 2008 037 030 B3. The electrical connector exhibits two shielding parts capable of being connected to one another, with a region of the one shielding part and a region of the other shielding part overlapping in an overlay portion.

A disadvantage with the known possibilities is that they do not guarantee the shield transfer directly in/on the plug connector. Furthermore, the known solutions can be utilized only by using auxiliary means such as screws, cable fasteners or crimp regions. In addition, crimped shield linkages, for instance, cannot be disconnected non-destructively. However, an incorrect shield transfer leads to an undesirable, disturbed transmission of the currents and/or signals, which in turn can lead to a malfunction of a coupled device. A further disadvantage of shielding metal plates known hitherto is that the shield transfers cannot be adapted to various conductor cross-sections, so that the appropriate shield transfer always has to be selected for a trouble-free transmission.

### SUMMARY

The object of the invention consists in proposing a shielding metal plate that guarantees a simple, reversible, variable and robust contacting of the shield of an electrical conductor.

The object is achieved by the shielding metal plate as claimed.

Advantageous configurations of the invention are specified in the dependent claims.

The present invention relates to a shielding metal plate. Said shielding metal plate exhibits a plug-in side. The plug-in side serves for contacting the plug connector with a mating connector.

Opposite the plug-in side the shielding metal plate exhibits a coupling side. The coupling side serves for coupling at least one electrical conductor. The coupling side preferably serves for coupling at least one electrical shielded conductor.

The conductor is capable of being received in a contact element. The contact element may be a crimp contact, for instance. The at least one contact element is capable of being received in the shielding metal plate and comes into contact with the latter, so that a secure shield transfer is guaranteed.

The shielding metal plate consists of a conductive material, preferably a metal. Alternatively, the shielding metal plate consists of a synthetic material coated with a conductive alloy. The shielding metal plate exhibits an upper side and an underside, each with a coupling side and a plug-in side.

The shielding metal plate may be adaptable to various cross-sections of conductors by means of at least one latching mechanism. In preferred manner, the upper side of the coupling side and the underside of the coupling side are U-shaped. When the upper side of the coupling side and the underside of the coupling side are joined together, a tube-like, round opening results. A conductor is capable of being inserted into this opening in the direction of the plug-in side.

The upper side of the coupling side and the underside of the coupling side each exhibit detent means. Through the use of the at least one latching mechanism, the shielding metal plate is capable of being employed universally for the most diverse conductor cross-sections, for “thin” and “thick” conductors equally. Thin conductors have a conductor cross-section of less than 2.5 mm². Thick conductors, on the other hand, have a conductor cross-section greater than or equal to 2.5 mm².

The shielding of the conductor may either be held between the upper side and the underside, from the coupling side as far as the plug-in side. For this purpose, only a possible insulation on the conductor has to be removed. Alternatively, after the removal of the insulation the shielding of the conductor may also be folded over, so that it points from the coupling side in the direction of the coupled conductor, consequently away from the plug-in side. The first variant is advantageous for the coupling of thicker conductors, whereas the second variant is preferably suitable for the coupling of thinner conductors.

By virtue of the at least one latching mechanism, a secure, disconnectable contacting of the shielding is always afforded, irrespective of the conductor cross-section. Consequently a gas-tight contacting obtains which is possible without a laborious manufacture of the conductor.

In the case of the at least one latching mechanism, it is a question of a first detent lug and an associated first detent recess. The shape of the first detent lug may be round or angular. The first detent recess has accordingly been shaped for receiving the first detent lug, so that the latter is capable of being received in the detent recess in securely latching manner.

In a first variant, the underside of the coupling side of the shielding metal plate is provided with at least one first detent lug, and the upper side of the coupling side with at least one first detent recess. In this case, the first detent lug and the first detent recess have been arranged on the upper side of the coupling side and on the underside of the coupling side in such a way that they are capable of being latched with one another.

In a preferred first practical form, the underside of the coupling side is provided with at least one first detent lug. The upper side of the coupling side exhibits at least two first detent recesses. These at least two first detent recesses ideally take the form of detent steps. The detent steps enable the coupling of various conductor cross-sections, since through the use of the detent steps the spacing between the upper side of the coupling side and the underside of the coupling side is variably adjustable.

In a second, alternative variant, the underside of the coupling side exhibits at least one first detent recess, and the upper side of the coupling side exhibits at least one first detent lug. In this case, the first detent recess and the first detent lug have been arranged on the upper side of the coupling side and on the underside of the coupling side in such a way that they are capable of being latched with one another.

The second variant preferentially exhibits an underside of the coupling side with at least two first detent recesses which take the form of detent steps. As in the first variant, the detent steps serve for variable adaptability to various conductors. The upper side of the coupling side exhibits at least one first detent lug.

In a further, third variant of the invention, the underside of the coupling side exhibits at least one first detent lug. Furthermore, the underside of the coupling side exhibits, opposite the first detent lug, at least two first detent recesses. The at least two first detent recesses take the form of detent steps.

Correspondingly, the upper side of the coupling side exhibits at least one first detent lug. The first detent lug of the upper side of the coupling side has been arranged appropriately for the latching mechanism in one of the detent steps of the underside of the coupling side. In addition, the upper side of the coupling side exhibits at least two first detent recesses. The latter have been shaped as detent steps and arranged opposite the first detent lug of the upper side of the coupling side and opposite the first detent lug of the underside of the coupling side. The first detent lug of the underside of the coupling side can latch in one of the detent steps of the upper side of the coupling side. This variant offers the advantage of the greatest possible adaptability, since various detent positions are possible on the upper side of the coupling side and on the underside of the coupling side of the shielding metal plate, depending upon the thickness of the conductor.

Regardless of the chosen variant, the at least one first detent lug and the at least one first detent recess have been aligned in the direction of the coupling side. By virtue of the positioning of the at least one first detent lug and the at least one first detent recess on the coupling side, not only a secure contacting of the shielding but also an early contacting take place. Furthermore, in this way a strain relief for the conductor is afforded at the same time, since the latter is held over a large area.

In one variant, the shielding metal plate has been formed in one piece. This means that the region of the upper side of the plug-in side and of the underside of the plug-in side has been formed from one piece, onto which, corresponding to the respective side, the upper side of the coupling side and the underside of the coupling side have been formed. The upper side of the coupling side and the underside of the coupling side in this case have been designed to be elastic and have been positioned so as to be capable of being latched with one another.

Alternatively, the shielding metal plate has been formed from two parts. In this case, the upper side of the coupling side and the upper side of the plug-in side have been formed from one piece; the underside of the coupling side and the underside of the plug-in side constitute the other piece.

In the direction of the plug-in side the shielding metal plate exhibits at least one second detent lug on the upper side of the plug-in side, and at least one associated second detent recess on the underside of the plug-in side. Alternatively, the upper side of the plug-in side exhibits at least one second detent recess, and the underside of the plug-in side exhibits at least one second detent lug.

In preferred manner, at least one second detent lug and at least one second detent recess have been formed on the upper side of the plug-in side, and at least one second detent lug and at least one second detent recess have been formed on the underside of the plug-in side in the direction of the plug-in side. As a result, a stable and secure latching is afforded in the region of the complete shielding metal plate.

The at least one second detent lug and the at least one second detent recess are only necessary in the case of multi-part construction of the shielding metal plate.

The second detent recess and the second detent lug may have been constructed to be identical in shape to the first detent lug and to the first detent recess. Alternatively, the second detent lug and the second detent recess may also have a different shape than the first detent lug and the first detent recess. Accordingly, the shape of the first detent lug and of the first detent recess may be angular, and the shape of the second detent lug and of the second detent recess may be elliptical. Alternatively, the shape of the first detent lug and of the first detent recess may be elliptical, and the shape of the second detent lug and of the second detent recess may be angular. In a further alternative, other shapes are also conceivable. With any shape, however, the latching has to be guaranteed.

A third detent lug has been arranged on the upper side or on the underside or on the upper side and underside. Said lug has been designed to be resilient and elastic and points inward toward an inserted conductor. Said lug has been formed on the coupling side and/or on the plug-in side, the resilient arm of the third detent lug pointing in the direction of the plug-in side. Advantageously, a flexible safety device is generated by this means. The flexible strain relief is afforded when a conductor is pushed from the coupling side into the shielding metal plate in the direction of the plug-in side. In the process, the third detent lug springs slightly away from the inserted conductor. However, the third detent clamps the inserted conductor in its position when said conductor is subjected to traction from the plug-in side to the coupling side. In the process, the third detent lug tightens and in this way secures the inserted conductor. The third detent lug acts in accordance with the principle of Hertzian contact stress and consequently ensures a low-impedance resistance.

A fourth detent lug has been formed on the upper side of the plug-in side or on the underside of the plug-in side or on the upper side of the plug-in side and on the underside of the plug-in side. The fourth detent lug exhibits a resilient arm. The resilient arm points in the direction of the plug-in side. The fourth detent lug serves for latching the entire plug connector with a corresponding mating connector.

The present invention achieves the object of presenting a shielding metal plate having a safe and yet disconnectable shield linkage, it being possible for the shield linkage to be flexibly adapted to the most diverse conductor cross-sections. Furthermore, the shield linkage is constructed to be compact, space-saving and robust. By virtue of the reversible shield linkage, an initial wiring, a correction and/or a repair of a complete plug connector is/are also readily possible.

### BRIEF DESCRIPTION OF THE DRAWINGS

An embodiment of the invention is represented in the drawings and will be elucidated in more detail in the following.

FIG. 1 is a perspective representation of the upper side and of the underside of the shielding metal plate.

FIG. 2 is a perspective representation of an assembled shielding metal plate.

FIG. 3 is a perspective representation of the preferred upper side.

### DETAILED DESCRIPTION

The figures contain partially simplified, schematic representations. In part, identical reference symbols are used for the same but possibly not identical elements. Different views of the same elements might have been scaled differently.

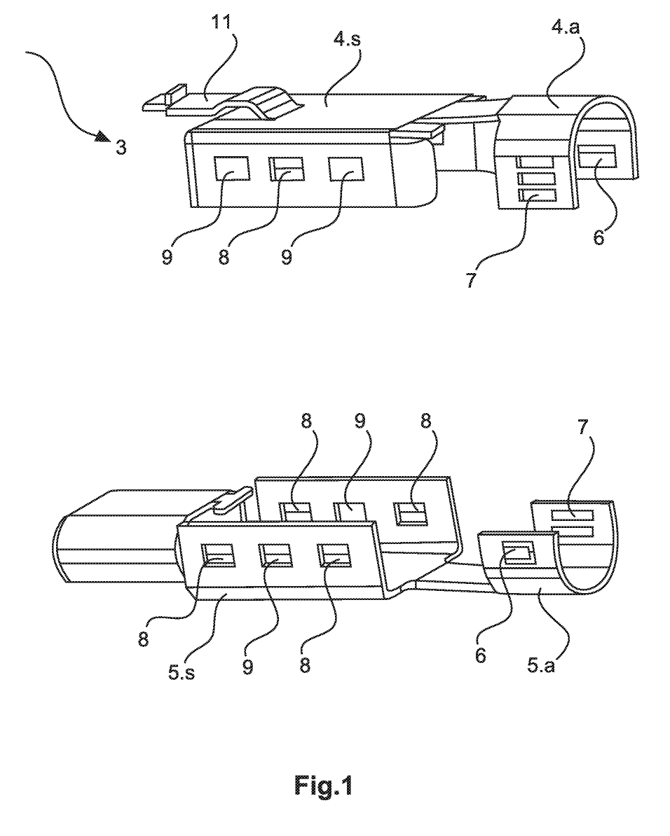

FIG. 1 shows a perspective representation of an upper side according to the invention and of an underside according to the invention, which together form a shielding metal plate 3 according to the invention. The upper side exhibits a coupling side 4a and a plug-in side 4.s. The underside exhibits a coupling side 5.a and a plug-in side 5.s.

This shielding metal plate 3 is capable of being received in a housing of a plug connector. The housing is, in turn, capable of being received in a plug connector. However, for reasons of better representation, the housing and the plug connector have not been shown here.

The underside of the plug-in side 5.s is constituted by a region for receiving a mating connector. In this region a mating connector can be contacted. The plug-in side has been designed in the form of a hollow right parallelepiped with two integrally formed semicylinders. One of the two semicylinders has been formed respectively on one of the two short sides of the hollow right parallelepiped. In a mounted state, at least one contact element projects into this region between the two semicylinders.

Opposite the underside of the plug-in side 5.s the shielding metal plate 3 exhibits an underside of the coupling side 5.a. This underside serves for coupling at least one shielded conductor, said shielded conductor being capable of being received in a contact element which is then capable of being inserted into the shielding metal plate 3 from the underside of the coupling side 5.a in the direction of the underside of the plug-in side 5.s.

The underside of the coupling side 5.a is U-shaped. Said underside exhibits a first detent lug 6 on the one side, on one leg of the U of the first underside 5.a. The first detent lug 6 is of angular construction. Opposite this first detent lug 6, two first detent recesses 7 have therefore been formed on the correspondingly opposite leg of the underside of the coupling side 5.a. Use may also be made of any other number of first detent recesses 7. The first detent recess 7 in the present embodiment is of rectangular construction. However, the first detent recesses 7 may assume any shape, which have to be chosen only in accordance with the shape of the first detent lugs 6, in order that those are capable of being received and latched in the first detent recesses 7.

The two first detent recesses 7 have been arranged as detent steps. For this purpose, it is advantageous if at least two first detent recesses have been arranged on the coupling side. In order that the first detent recesses form detent steps, they have been aligned exactly one above the other in the direction of the opening of the U. This offers the advantage that a corresponding first detent lug is able to catch in various positions, depending upon the conductor cross-section.

The underside of the coupling side 5.a and the underside of the plug-in side 5.s are connected by a transition region which belongs partly to the plug-in side and partly to the coupling side. The transition region connects the base surface of the right parallelipiped of the plug-in side to the low-point straight line of the U of the coupling side. A broad rectangular surface with narrow rectangular surfaces formed on the long sides of the broad surface constitutes the transition region.

Second detent lugs 8 and second detent recesses 9 have been formed on or in the narrow rectangular surfaces. In the present embodiment, on one of the two narrow surfaces the transition region exhibits two second detent lugs 8 and one second detent recess 9. Two second detent lugs 8 and one second detent recess 9 have been arranged on the opposite surface. This is an exemplary distribution of the second detent lugs 8 and the second detent recesses 9. Other distributions/numbers per narrow side are also possible.

The upper side according to the invention exhibits an upper side of the plug-in side 4.s, a transition region and an upper side of the coupling side 4.a. However, the upper side of the plug-in side 4.s has been designed without the right-parallelepipedal region which has been formed on the underside of the plug-in side 5.s. The transition region consists, just as in the case of the transition region of the underside, of a broad, rectangular surface with narrow rectangular surfaces formed on the long sides of the broad surface.

The transition region exhibits a fourth detent lug 11. The fourth detent lug 11 is provided for the purpose of latching with a mating connector. Said detent lug has been formed in resilient manner on the broad surface, and points in the direction of the plug-in side. The fourth detent lug 11 is provided with at least one barb—in this case, with two barbs which latch in the mating connector.

On one of the two narrow surfaces, two second detent recesses 9 and one second detent lug 8 have been formed as a counterpart to the underside of the plug-in side 5.s, with which the upper side of the plug-in side 4.s is capable of being latched. Likewise, two second detent recesses 9 and one second detent lug 8 have been arranged on the opposite narrow surface.

The both narrow surfaces have been assembled identically is—as already mentioned in connection with the underside of the plug-in side 5.s—only one possible practical form. For instance, only one second detent lug 8 may have been arranged on the one narrow surface, and one second detent recess 9 on the opposite narrow surface. The narrow surfaces of the upper side of the plug-in side 4.s must only have been provided with a number of second detent recesses 9 corresponding to the second detent lugs 8 exhibited by the second underside 5.s. This applies analogously to the second detent lugs 8 of the second upper side 4.s.

The upper side of the coupling side 4.a is—like the underside of the coupling side 5.a—configured in the shape of a U. One leg of the U exhibits a first detent lug 6. Said detent lug has been arranged on the leg in such a way that it is able to engage into one of the first detent recesses 7 of the underside of the coupling side 5.a. Three first detent recesses 7 have been formed on the opposite leg of the U. Depending on the thickness of the conductor cross-section that is to be received, the first detent lug 6 of the underside of the coupling side 5.a will latch into one of these three first detent recesses 7.

The same rule applies to the shape of the first detent lug 6 and of the first detent recess 7 on the upper side of the coupling side 4.a as to the first detent recesses 7 and first detent lugs 6 that have been arranged on the underside of the coupling side 5.a.

The first detent recesses 7 on the upper side of the coupling side 4.a take the form of detent steps analogous to the first detent recesses 7 of the underside of the coupling side 5.a. They have been arranged correspondingly, one above the other. The number of first detent recesses 7 on the upper side of the coupling side 4.a and on the underside of the coupling side 5.a, whether identical or different, is arbitrary.

The upper side 4.a, 4.s and also the underside 5.a, 5.s have consequently been shaped in such a way that they are capable of being latched with one another and hold a received conductor securely. As a result, the shielding of the received conductor is advantageously contacted over a large area.

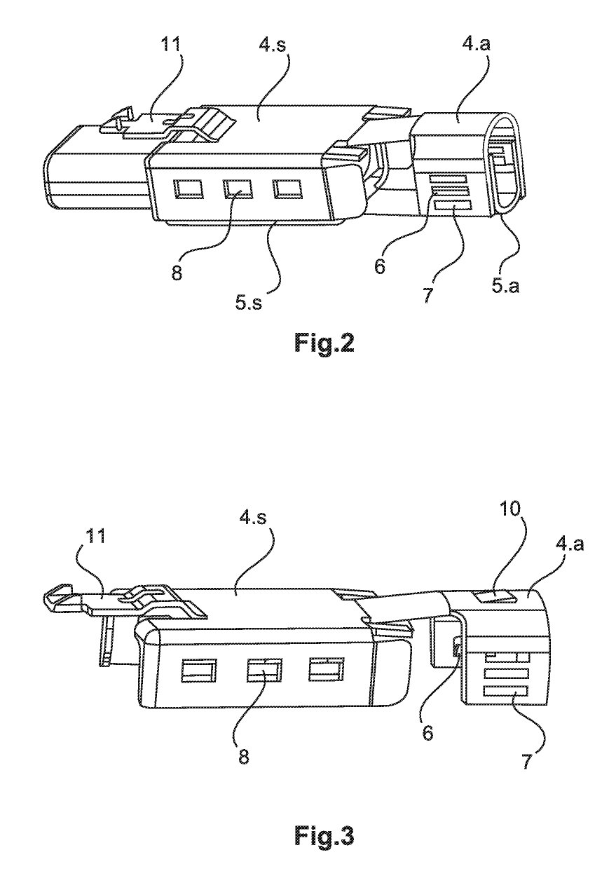

In FIG. 2 the upper side 4.a, 4.s and also the underside 5.a, 5.s shown in FIG. 1 have been latched with one another. In FIG. 2 the underside of the plug-in side 5.s with the right-parallelepipedal and semi-cylindrical plug-in side, the transition region, and the underside of the coupling side 5.a as opposing U-shaped coupling side are represented.

The fourth detent lug 11 of the upper side of the plug-in side 4.s projects in the direction of the plug-in side and is positioned close to the right-parallelepipedal and semi-cylindrical region of the plug-in side of the underside of the plug-in side 5.s.

In this embodiment the underside of the plug-in side 5.s exhibits in the transition region three second detent recesses 9, into which the three second detent lugs 8 of the upper side of the plug-in side 4.s latch.

On the coupling side of the underside of the coupling side 5.a a first detent lug 6 has been formed on one leg of the U, toward the observer, and two first detent recesses 7 have been formed on the opposite leg. The upper side of the coupling side 4.a exhibits toward the observer three first detent recesses 7 and, situated opposite, one first detent lug 6. The first detent lug 6 of the underside of the coupling side 5.a engages into the middle one of the three first detent recesses 7 of the upper side of the coupling side 4.a. The first detent lug 6 of the upper side of the coupling side 4.a latches opposite into the first detent recess 7 of the underside of the coupling side 5.a, which has been arranged closer to the curved region of the U.

Which first detent recess 7 the respective detent lug 6 has engaged into is dependent on the respective conductor to be coupled.

In FIG. 3 a preferred practical form of the upper side 4.a, 4.s is represented in perspective view. The upper side of the plug-in side 4.s exhibits the fourth detent lug 11 with two barbs in the direction of the plug-in side. In the transition region three second detent lugs 8 have been arranged on the one narrow surface and, situated opposite, three second detent recesses 9.

The coupling side of the upper side of the coupling side 4.a adjoins the transition region. Said coupling side is U-shaped. Three first detent recesses 7 have been formed on one of the legs of the U. A first detent lug 6 has been formed on the opposite leg of the U.

Particularly preferred is the formation of a third detent lug to on the curved region of the U which connects the two legs of the U to one another. The third detent lug to offers the advantage of an additional contacting of a shielding of a conductor to be coupled, and is additionally a strain relief. The strain-relieving action is afforded by the orientation of the third detent lug to, which in the direction of the plug-in side has been formed in resilient manner on the upper side of the coupling side 4.a.

### LIST OF REFERENCE SYMBOLS

3 shielding metal plate
4.a upper side of the coupling side
4.s upper side of the plug-in side
5.a underside of the coupling side
5.s underside of the plug-in side
6 first detent lug
7 first detent recess
8 second detent lug
9 second detent recess
10 third detent lug
11 fourth detent lug

1.-12. (canceled)

13. A shielding metal plate having a plug-in side and a coupling side,
wherein the coupling side is arranged opposite the plug-in side,
wherein the plug-in side is suitable for contacting a mating connector,
wherein the coupling side is suitable for coupling at least one shielded conductor,
wherein the at least one conductor is capable of being connected to at least one contact element,
wherein the shielding metal plate has an upper side and an underside,
wherein the shielding metal plate is capable of being received in a housing of a plug connector,
wherein the at least one contact element is capable of being received in the shielding metal plate,
wherein the at least one contact element comes into contact with the shielding metal plate, and
wherein the shielding metal plate is adaptable to various conductor cross-sections by at least one latching mechanism.

14. The shielding metal plate as claimed in claim 13,
wherein the at least one latching mechanism comprises a first detent lug and an associated first detent recess.

15. The shielding metal plate as claimed in claim 13,
wherein the latching mechanism is arranged on an upper side of the coupling side and on an underside of the coupling side of the shielding metal plate, and
wherein the upper side of the coupling side and the underside of the coupling side are arranged on the coupling side of the shielding metal plate.

16. The shielding metal plate as claimed in claim 15,
wherein the underside of the coupling side includes at least one first detent lug, and the upper side of the coupling side includes at least one first detent recess.

17. The shielding metal plate as claimed in claim 15,
wherein the underside of the coupling side includes at least one first detent lug, and the upper side of the coupling side includes at least two first detent recesses, the at least two first detent recesses being arranged as detent steps.

18. The shielding metal plate as claimed in claim 15,
wherein the underside of the coupling side includes at least one first detent recess, and the upper side of the coupling side includes at least one first detent lug.

19. The shielding metal plate as claimed in claim 18,
wherein the underside of the coupling side includes at least two first detent recesses, and the upper side of the coupling side includes at least one first detent lug, the at least two first detent recesses being arranged as detent steps.

20. The shielding metal plate as claimed in claim 13,
wherein the underside of the coupling side includes at least one first detent lug and, situated opposite, at least two first detent recesses, and the upper side of the coupling side includes at least two first detent recesses and, situated opposite, at least one first detent lug.

21. The shielding metal plate as claimed in claim 13,
wherein an upper side of the plug-in side and an underside of the plug-in side are arranged on the plug-in side.

22. The shielding metal plate as claimed in claim 21,
wherein the upper side of the plug-in side and the underside of the plug-in side are formed from one part, or
wherein the upper side of the plug-in side and the underside of the plug-in side are each formed from one part.

23. The shielding metal plate as claimed in claim 13,
wherein the upper side of the coupling side and/or the underside of the coupling side include(s) an elastically resilient third detent lug pointing inward toward the at least one conductor, and/or
wherein the upper side of the plug-in side and/or the underside of the plug-in side include(s) an elastically resilient third detent lug pointing inward toward the at least one conductor.

24. The shielding metal plate as claimed in claim 13,
wherein the upper side of the plug-in side and/or the underside of the plug-in side include(s) a fourth detent lug, the fourth detent lug being shaped for latching with a mating connector.
